(19) United States
(12) Patent Application Publication
(10) Pub. No.: US 2012/0100360 A1
(43) Pub. Date: Apr. 26, 2012

(54) Chemical resistant coatings

(76) Inventors: Juan Baõos, Glendora, CA (US); Ramon Baõos, Glendora, CA (US); Jose Baõos, Glendora, CA (US); Vanessa Baõos, Glendora, CA (US)

(21) Appl. No.: 12/925,441

(22) Filed: Oct. 20, 2010

(51) Int. Cl. B32B 5/02

(52) U.S. Cl. 428/221

(57) ABSTRACT

A Chemical Resistant Coating includes a first layer, a second layer, a third layer, and a fourth layer. The first layer is comprised of UV Promoted Polymer Resin. The second layer is comprised of Knytex®-Reinvorced Reinforced Matting. The third layer is comprised of UV Promoted Polymer Resin. The fourth layer is comprised of Brilliant White Low VOC Gel Coat. The second layer is disposed between the first layer and the third layer. In some preferred embodiments, a catalyst MEKP925 is added to expedite the chemical reaction.

### FIELD OF THE INVENTION

The present invention is in the area of construction materials, and pertains more particularly to chemical resistant coatings used upon various panels.

### BACKGROUND OF THE INVENTION

Oftentimes one of the problems many restaurants and other public facilities face is the maintenance of their interior walls. Many health and sanitation codes require fastidious standards of care with regards to cleanliness, hygiene, and contamination.

In response to these issues, many companies utilize various interior panels in their restrooms and other interior spaces. These panels are resistant to pathogens, germs, dirt, etc. Furthermore, they are easy to clean and sanitize due to the special surface coatings that make most stains only temporary.

On a related note, many food manufacturers have found that these panels can be beneficial with use in their own facilities. Since these interior panels are resistant to various germs, pathogens, and other corrosive chemicals, these panels with their corrosive resistant coatings prove to be of great use in maintenance, health, and safety. Unfortunately, one of the problems which inheres with these panels is in the affixation of these panels with the interior walls. Most of these panels are mated and held in place with a plastic joint. These plastic joints protrude outwards and create noticeable seams. Furthermore, the small spaces and crevices created by these joints can engender fertile ground for bacteria, germs, and other unsightly accretions. In addition, these seams are not very aesthetically pleasing.

Therefore, what is clearly needed in the art is a panel with a chemical resistant coating that is able to withstand various environmental forces such as temperature, humidity, paints, odors, and related materials.

These panels should be made for use with interior walls and ceilings. And these panels should be adaptable to many different types of uses.

### SUMMARY OF THE INVENTION

It is an object of the present invention to provide a chemical and moisture resistant panel which can be employed in the food, drug, and restaurant industries, as well as many others. The panels of the present invention are easy to wash and sanitize with simple soap and water.

Moreover, the construction of the panels is easily repaired with simple techniques.

It is an object of the present invention to provide moisture resistant panels. In addition, these panels are also resistant to heat, flame, and other toxic chemicals.

It is an object of the present invention to provide for a panel which can seamlessly integrate, mate, and dovetail with each other without the use of various plastic joints as seen in the prior art.

It is an object of the present invention to provide for a panel which is coated with a material that is impervious to many types of pathogens, chemicals, paints, and the like. Furthermore, these panels should be acceptable by many well-known standardization construction codes.

It is an object of the present invention to provide for a panel which is more aesthetically pleasing in the fact that there are no seams and no unsightly plastic joints.

It is an object of the present invention to provide for a seamless paneling system without crevices and other joints which may create areas lending themselves to unsanitary practices.

### BRIEF DESCRIPTION OF THE DRAWING FIGURES

FIG. 1 is a cross-sectional view of a preferred embodiment of the present invention.

FIG. 2 is a perspective view of a preferred embodiment of the present invention.

FIG. 3 is an elevation view of the prior art.

FIG. 4 is a cross-sectional view of the prior art.

FIG. 5 is a perspective view of the prior art.

FIG. 6 is a plan view of a preferred embodiment of the present invention.

FIG. 7 is an cross-sectional view of a preferred embodiment of the present invention.

FIG. 8 is a perspective view of a preferred embodiment of the present invention.

FIG. 9 is an cross-sectional view of a preferred embodiment of the present invention.

### DESCRIPTION OF PREFERRED EMBODIMENTS

According to a preferred embodiment of the present invention, a unique chemical resistant coating is applied to plywood or similar materials to create strong, durable, chemical and corrosion resistant panels. Moreover, these panels may be mated with each other to construct seamless surfaces. These resulting seamless walls are easier to clean and they are more aesthetically pleasing. The present invention is described in enabling detail below.

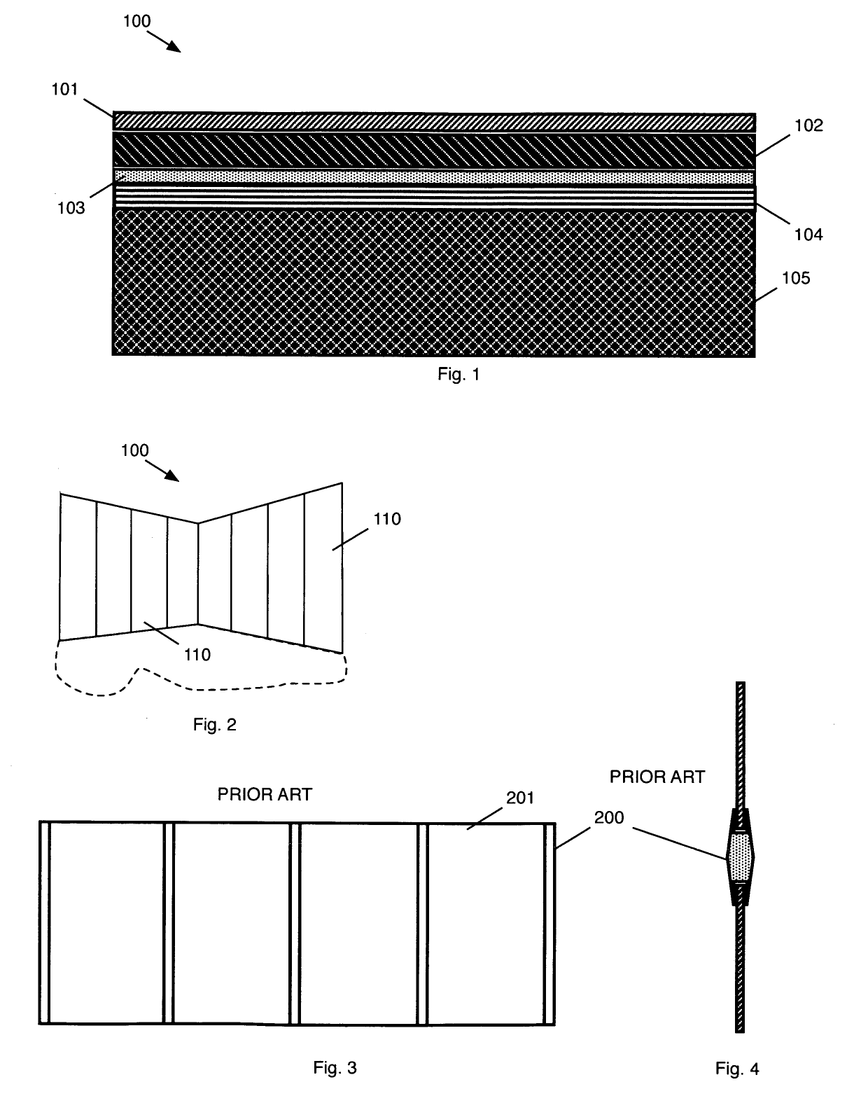

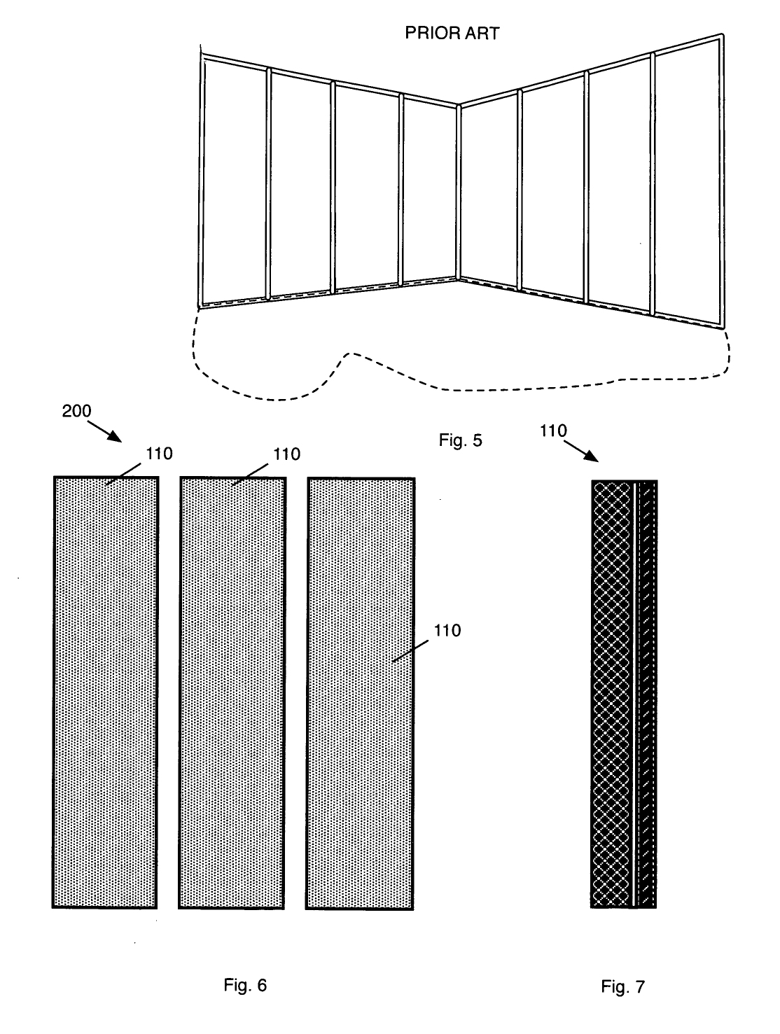

FIG. 1 illustrates a preferred embodiment of the present invention. A Chemical Resistant Coating 100 includes a first layer 101, a second layer 102, a third layer 103 and a fourth layer 104.

The first layer 101 is comprised of Brilliant White Low VOC Gel Coat. The Brilliant White Low VOC Gel Coat is used because it is flame retardant, and is very durable in quality. The second layer 102 is comprised of UV Promoted Polymer Resin. The third layer 103 is comprised of Knytex®-Reinvorced Reinforced Matting. (Knytex ® is a registered Trademark) In some preferred embodiments, the third layer may be an aerospace grade Knytex®-Reinvorced Reinforced Matting. The Knytex®-Reinvorced Reinforced Matting is used because it is extremely resistant to corrosive materials, and can mitigate contamination in the work area. The fourth layer 104 is comprised of UV Promoted Polymer Resin.

In some preferred embodiments, the Chemical Resistant Coating 100 is used in conjunction with a catalyst MEKP925 which helps to cure the chemicals. It should be noted that these layers can be altered in order in some preferred embodiments.

FIGS. 3 and 4 illustrate the resulting seams that is made in the prior art. Particularly, FIG. 4 illustrates how various joint members 200 are used to hold sheets 201 in place. In FIG. 2, one can appreciate the seamless surface walls which can be created with the Chemical Resistant Coating 100 of the present invention when it is applied to plywood members 105.

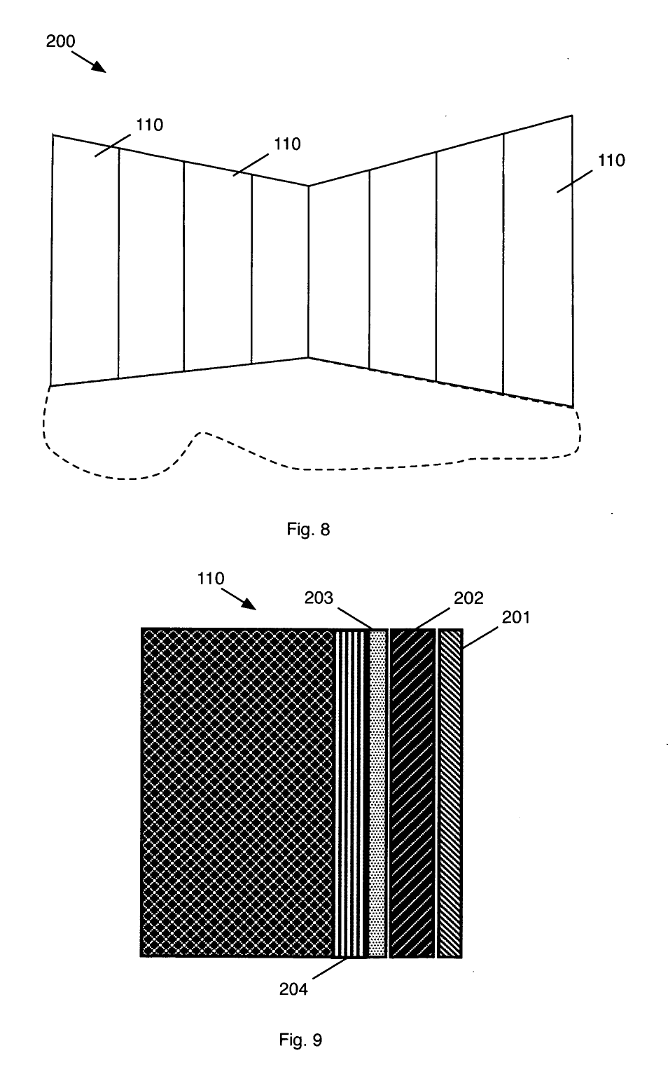

FIGS. 6 and 7 illustrate another preferred embodiment of the present invention. Seamless Board Assembly 200 is comprised of a plurality of planar members 110. The planar members are disposed against a wall and abut each other for the purpose of covering the walls of an interior structure. The Planar Member 110 is coated with a top coat 201 of Brilliant White Low VOC Gel Coat, a second coat 202 of UV Promoted Polymer Resin, a third coat 203 of Knytex®-Reinvorced Reinforced Matting, and a fourth coat 204 of UV Promoted Polymer Resin. The fourth coat is disposed upon the planar member 110. In some preferred embodiments, the planar member is plywood. FIG. 8 illustrates the difference between the Seamless Board Assembly 200 and the prior art in that there are no seams and protruding surfaces.

In some preferred embodiments, there may be additional curing processes which may take place. One example would be to pass the coating of the plywood to be subjected to UV Radiation or other catalyzing process.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Chemical Resistant Coating comprising: a first layer, a second layer, a third layer, and a fourth layer;
the first layer is comprised of Brilliant White Low VOC Gel Coat;
the second layer is comprised of UV Promoted Polymer Resin;
the third layer is comprised of Knytex®-Reinvorced Reinforced Matting;
the fourth layer is comprised of UV Promoted Polymer Resin.

2. A Seamless Board Assembly 200 comprising: a plurality of planar members; the planar members are disposed such that they abut each other; the planar members are coated with a top coat of Brilliant White Low VOC Gel Coat, a second coat of UV Promoted Polymer Resin, a third coat of Knytex®-Reinvorced Reinforced Matting, and a fourth coat of UV Promoted Polymer Resin.

3. The Chemical Resistant Coating of claim 1 further comprising a catalyst; the catalyst is MEKP925.
